(19) United States
(12) Patent Application Publication
(10) Pub. No.: US 2025/0202301 A1
(43) Pub. Date: Jun. 19, 2025

(54) MOTOR

(71) Applicant: MINEBEA MITSUMI Inc., Nagano (JP)

(72) Inventor: Seiya FUJIMOTO, Kitasaku-gun, Nagano (JP)

(21) Appl. No.: 18/847,331

(22) PCT Filed: Feb. 14, 2023
(86) PCT No.: PCT/JP2023/004965

§ 371 Date: Sep. 16, 2024

(30) Foreign Application Priority Data
Mar. 31, 2022 (JP) 2022-059153

(51) Int. Cl. H02K 1/2791

(52) U.S. Cl. CPC H02K 1/2791

(57) ABSTRACT

A motor capable of improving motor performance is provided. A motor includes a rotor and a stator opposing the rotor. The rotor includes a magnet, a yoke in contact with the magnet, and a holder holding the magnet and the yoke. The yoke includes a first end part defined at one end in a circumferential direction and a second end part defined at another end in the circumferential direction. In a radial direction, an inner peripheral surface of the yoke opposes an outer peripheral surface of the holder via a first gap.

### TECHNICAL FIELD

The present invention relates to a motor.

### BACKGROUND ART

Conventionally, in a rotor, a magnet is fixed to an inner peripheral surface of a yoke with, for example, an adhesive, as disclosed in Patent Document 1.

### CITATION LIST

### Patent Literature

Patent Document 1: JP 2019-68604 A

### SUMMARY OF INVENTION

### Technical Problem

It is difficult to ensure high accuracy to size in a yoke, and a gap may be formed between an outer peripheral surface of a magnet and an inner peripheral surface of the yoke. This gap may become a cause of magnetic resistance and decrease motor performance.

The present invention has been made in light of the above problem, and an object is to provide a motor capable of improving motor performance.

### Solution to Problem

To achieve the above object, a motor according to the present invention includes
a rotor,
a stator opposing the rotor, wherein
the rotor includes a magnet, a yoke in contact with the magnet, and a holder holding the magnet and the yoke,
the yoke includes a first end part defined at one end in a circumferential direction and a second end part defined at another end in the circumferential direction, and
an inner peripheral surface of the yoke opposes an outer peripheral surface of the holder via a first gap in a radial direction.

### BRIEF DESCRIPTION OF DRAWINGS

FIG. 1 is a perspective view schematically illustrating an external appearance of a motor 1 according to an embodiment of the present invention.

FIG. 2 is a perspective cross-sectional view taken along line 2-2 in FIG. 1.

FIG. 3 is a cross-sectional view taken along line 3-3 in FIG. 1.

FIG. 4 is a perspective view of a yoke 22 alone, the perspective view schematically illustrating a configuration of the yoke 22.

FIG. 5 is a cross-sectional view taken along line 5-5 in FIG. 1.

FIG. 6 is a perspective view of a yoke 22A alone according to a modification example, the perspective view schematically illustrating a structure of the yoke 22A.

FIG. 7 is a perspective view of a yoke 22B alone according to another modification example, the perspective view schematically illustrating a structure of the yoke 22B.

### DESCRIPTION OF EMBODIMENTS

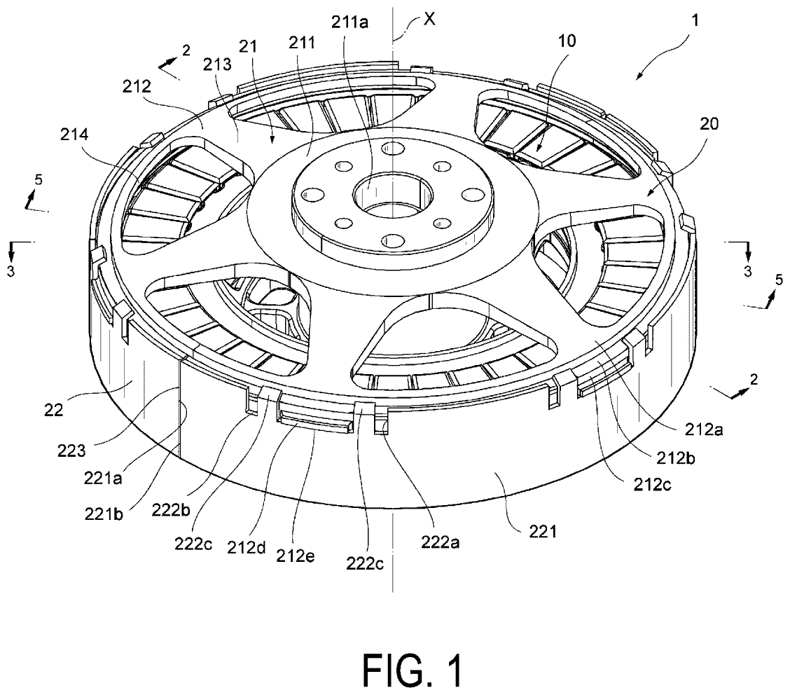

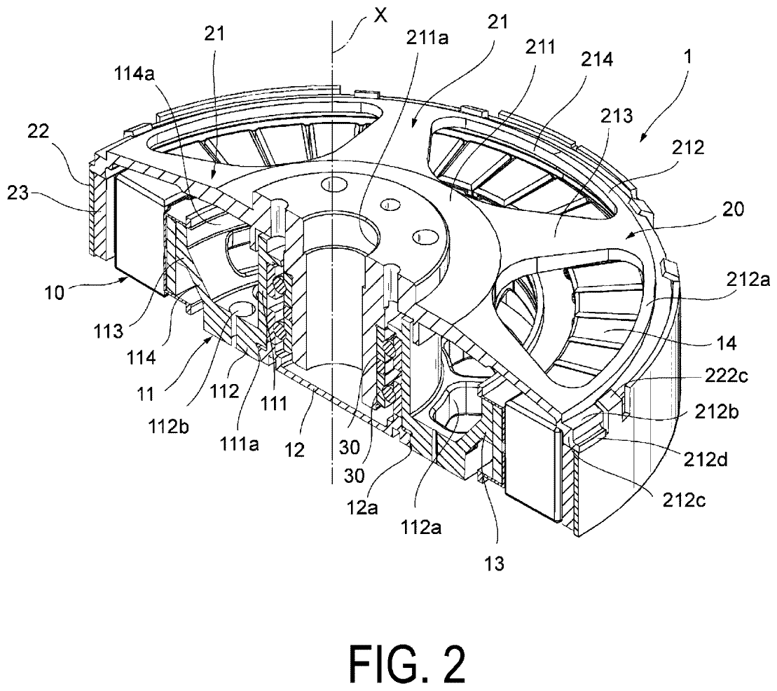

An embodiment of the present invention will be described below with reference to the drawings. FIG. 1 is a perspective view schematically illustrating an external appearance of a motor 1 according to the embodiment of the present invention. FIG. 2 is a perspective cross-sectional view taken along line 2-2 in FIG. 1. The motor 1 is, for example, a brushless motor of an outer-rotor type and, as illustrated in FIGS. 1 and 2, has, for example, a contour of a substantially flat cylindrical column shape. The motor 1 includes a stator 10 and an annular rotor 20 supported by the stator 10 rotatably about an axial line X and opposing the starter 10.

Note that in the following description of the present embodiment, an extending direction of the axial line X is referred to as an axial line X direction. Further, in the axial line X direction, one direction side is defined as an upper side, and another direction side is defined as a lower side. For example, in FIGS. 1 and 2, a side of disposing the stator 10 is defined as the lower side, and a side of disposing the rotor 20 is defined as the upper side. Further, a direction orthogonal to the axial line X is defined as a radial direction. In the radial direction, a side toward the axial line X is defined as an inner peripheral side or an inner side in the radial direction, and a side away from the axial line X is defined as an outer peripheral side or an outer side in the radial direction. Moreover, a direction around the axial line X is defined as a circumferential direction.

First, the stator 10 will be described. As illustrated in FIG. 2, the stator 10 includes a housing 11 constituting a base of the motor 1. The housing 11 includes an inner wall part 111 defined at the inner peripheral side, an attachment part 112 continuous with a lower side of the inner wall part 111, an outer wall part 113 defined at the outer peripheral side, and a connection part 114 connecting the attachment part 112 and the outer wall part 113. The inner wall part 111, the attachment part 112, the outer wall part 113, and the connection part 114 are integrally formed of a non-magnetic material including a metal material such as aluminum or a resin material.

The inner wall part 111 is formed in a cylindrical shape with the axial line X as a central axis. An upper end and a lower end of the inner wall part 111 are open. Outer rings of two bearings 30 and 30 aligned in the axial line X direction are held at an inner peripheral surface of the inner wall part 111. The bearings 30 are fitted into the inner wall part 111 and fixed to the inner peripheral surface of the inner wall part 111 with an adhesive. However, the bearings 30 may be fixed to the inner peripheral surface of the inner wall part 111 by a given method such as press fitting, transition fitting, or clearance fitting. The inner wall part 111 functions as a bearing holder (bearing holding part) of the two bearings 30 and 30. The bearings 30 are ball bearings, for example. However, other bearings such as a sleeve bearing may be used as the bearings 30.

A pusher 12 formed in a thin plate-like disk shape is fixed to an opening at the lower end of the inner wall part 111. The pusher 12 has a function to apply a preload to the bearings 30 and 30. For example, a male screw 12a is formed at an outer peripheral surface of the pusher 12. On the other hand, a female screw 111a is formed at an inner peripheral surface of the opening at the lower end of the inner wall part 111. Thus, the pusher 12 is fixed to the opening at the lower end of the inner wall part 111 by being screwed into the opening at the lower end of the inner wall part 111. The pusher 12 is formed of, for example, a metal material such as aluminum or a resin material. Note that although the bearings 30 apply a preload by constant-position preloading using the pusher 12, no such limitation is intended. For example, an elastic member such as a spring or a plate spring may be disposed between the bearings 30 and the pusher 12, and a preload may be applied to the bearings 30 by constant-pressure preloading.

The attachment part 112 is a part for attaching the motor 1 to an external device (not illustrated). The attachment part 112 is formed in a flat annular shape extending from the lower end of the inner wall part 111 toward the outer peripheral side. A plurality of (for example, eight) opening parts 112a aligned in the circumferential direction are formed in the attachment part 112. Each opening part 112a extends through the attachment part 112 in the axial line X direction. The opening parts 112a allow flow of air from the inside of the motor 1 to the external space, for example. A plurality of screw holes 112b for attaching the motor 1 to the external device are further formed in the attachment part 112.

The outer wall part 113 is formed in a cylindrical shape with the axial line X as a central axis. An inner peripheral surface of the outer wall part 113 opposes an outer peripheral surface of the inner wall part 111. An upper end of the attachment part 112 and a lower end of the outer wall part 113 are connected to each other by the connection part 114. The connection part 114 is inclined so as to extend upward from the attachment part 112 toward the outer wall part 113. A plurality of (for example, eight) opening parts 114a aligned in the circumferential direction are formed in the connection part 114. The opening parts 114a extend through the connection part 114 in the axial line X direction. The opening parts 114a allow flow of air from the inside of the motor 1 to the external space, for example.

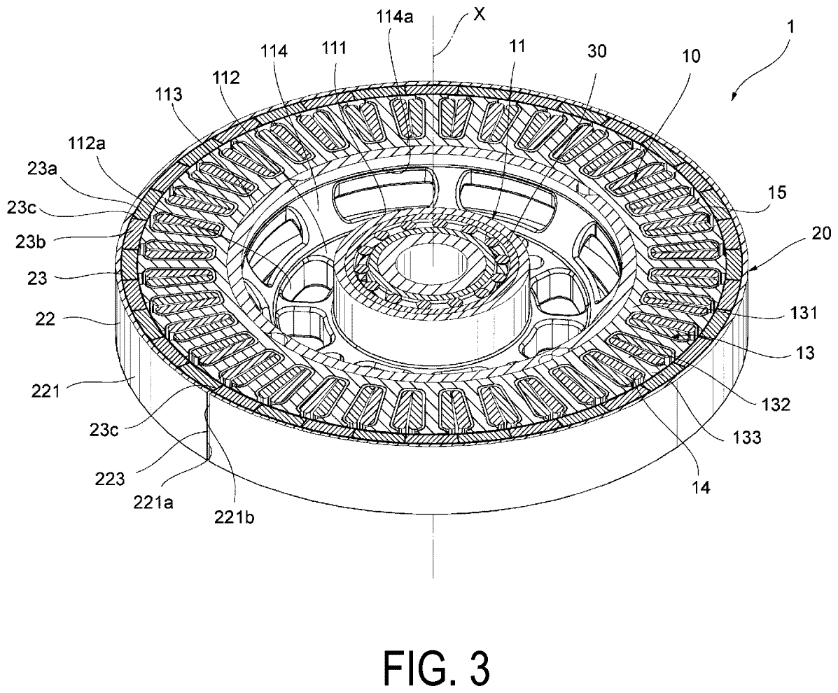

FIG. 3 is a cross-sectional view taken along line 3-3 in FIG. 1. Referring also to FIG. 3, the stator 10 includes a stator core 13 fixed to an outer peripheral surface of the outer wall part 113 of the housing 11, a plurality of coils 14 wound around the stator core 13, and a plurality of insulators 15 disposed between the stator core 13 and the respective coils 14. The stator core 13 is formed of a stacked body of silicon steel plates or the like being magnetic materials, and functions as a yoke of the stator 10.

The stator core 13 includes a base end part 131 having a cylindrical shape, a plurality of (for example, 36) teeth 132 extending in the radial direction from the base end part 131 toward the outer peripheral side, and a distal end part 133 defined at an outer peripheral end of each of the teeth 132. An inner peripheral surface of the base end part 131 is held at the outer peripheral surface of the outer wall part 113 of the housing 11 using, for example, an adhesive. The teeth 132 are aligned at equal intervals in the circumferential direction. The size of each distal end part 133 defined in the circumferential direction is set to be larger than the size of each tooth 132 similarly defined in the circumferential direction.

The coils 14 are held by the stator core 13, that is, the housing 11, by being wound around the respective teeth 132. The insulators 15 formed of an insulation material are disposed between the stator core 13 and the coils 14. Thus, electrical insulation is ensured between the stator core 13 and the coils 14. Note that, instead of disposing the insulators 15, electrical insulation may be ensured by applying or forming a resin film having insulating properties at a surface of the stator core 13.

Next, the rotor 20 will be described. Referring also to FIGS. 1 to 3, the rotor 20 includes a substantially disc-shaped holder 21 rotatably supported by the inner wall part 111 of the housing 11 of the stator 10 via the bearings 30 and 30, a yoke 22 having a cylindrical shape and attached to an outer peripheral end of the holder 21, and a magnet (permanent magnet) 23 having a cylindrical shape and attached to an inner peripheral surface of the yoke 22. An inner peripheral surface of the magnet 23 opposes outer peripheral surfaces of the distal end parts 133 of the stator core 13 of the stator 10 via a gap. Note that, although the magnet 23 has a cylindrical shape, a single magnet may be formed in a cylindrical shape, or a plurality of magnets may be connected to form a cylindrical shape.

The holder 21 includes an inner peripheral part 211 having a substantially cylindrical shape and defined at the inner peripheral side, an annular outer peripheral part 212 defined at the outer peripheral side, a plurality of (for example, six) connection members, that is, spokes 213 connecting the inner peripheral part 211 and the outer peripheral part 212 to each other, and a plurality of (for example, eight) opening parts 214 defined between the mutually adjacent spokes 213 and 213, the opening parts 214 being defined between the inner peripheral part 211 and the outer peripheral part 212. The inner peripheral part 211, the outer peripheral part 212, and the spokes 213 are integrally formed of a metal material such as aluminum or a resin material.

The inner peripheral part 211 is formed in substantially a cylindrical shape with the axial line X as a central axis. The inner peripheral part 211 includes a through hole 211a extending through the inner peripheral part 211 from an upper end to a lower end of the inner peripheral part 211. Inner rings of the bearings 30 and 30 are held at an outer peripheral surface of the inner peripheral part 211. For example, an adhesive (not illustrated) is used for holding. However, instead of the adhesive, the bearings 30 and 30 may be fixed to the inner peripheral part 211 by, for example, a given method such as press fitting, transition fitting, or clearance fitting to the outer peripheral surface of the inner peripheral part 211. Note that the through hole 211a does not need to be formed. In other words, the inner peripheral part 211 may have a shape of a cylindrical column solid.

Each spoke 213 extends in the radial direction between the inner peripheral part 211 and the outer peripheral part 212. In the present embodiment, the size of each spoke 213 defined in the circumferential direction decreases toward the outer peripheral side in the radial direction. The opening parts 214 are aligned at positions corresponding to the opening parts 114a of the housing 11, the stator core 13, and the coils 14 of the stator 10 in the axial line X direction. Thus, flow paths of air are formed between the opening parts 214 and the opening parts 114a in the axial line X direction. Note that the opening parts 214 may be aligned at positions corresponding to the opening parts 112a and flow paths of air may be formed between the opening parts 214 and the opening parts 112a.

The outer peripheral part 212 includes a first annular part 212a formed in an annular shape along outer peripheral ends of the spokes 213, and a second annular part 212c defined at the outer peripheral side of the first annular part 212a, the second annular part 212c defining, at an upper surface, a stepped surface 212b recessed downward in the axial line X direction from an upper surface of the first annular part 212a. As is clear from FIG. 2, a lower end of the second annular part 212c is in contact with and is received by an upper end of the magnet 23. The stepped surface 212b continuously extends in the circumferential direction and, for example, expands along a virtual plane orthogonal to the axial line X. The maximum diameter of the holder 21 is defined by the diameter of an outer peripheral surface of the second annular part 212c.

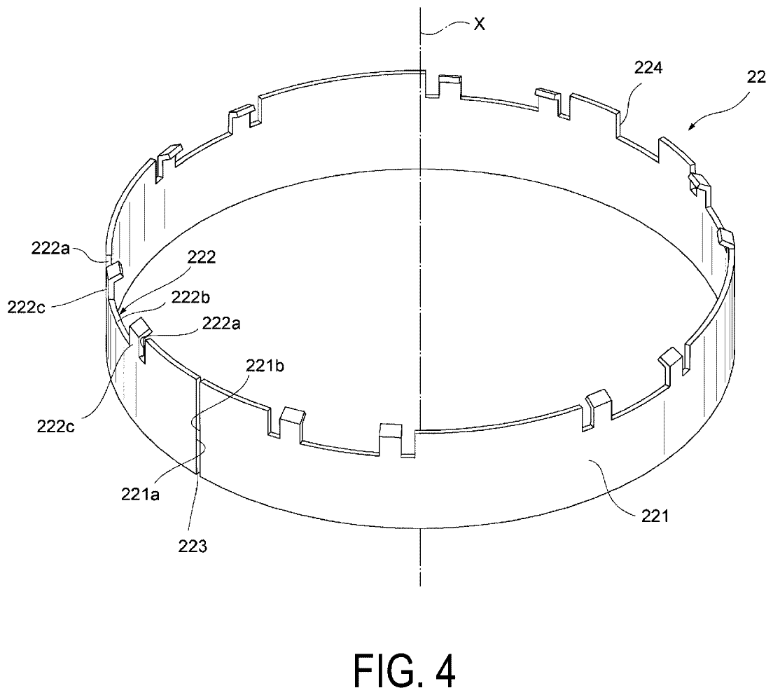

FIG. 4 is a perspective view of the yoke 22 alone, the perspective view schematically illustrating a configuration of the yoke 22. Referring also to FIGS. 1, 2 and 4, the yoke 22 is formed in a cylindrical shape with the axial line X as a central axis. The magnet 23 similarly formed in a cylindrical shape with the axial line X as a central axis is attached to the inner peripheral surface of the yoke 22. For example, an adhesive is used for fixing of the magnet 23. The yoke 22 is formed of a magnetic material such as iron.

The yoke 22 includes a main body 221 having a cylindrical shape. In the main body 221, a plurality of (for example, six) cutouts 222 are formed at equal intervals in the circumferential direction at an upper end of the main body 221. In the present embodiment, each cutout 222 is formed by, for example, a pair of side surfaces 222a and 222a defined along virtual planes including the axial line X and a bottom surface 222b defined along a virtual plane orthogonal to the axial line X. Thus, the cutout 222 is formed in, for example, a rectangular shape. The bottom surface 222b extends along substantially the same plane as an upper surface of the magnet 23, for example.

The yoke 22 includes, for example, two engaging parts (projecting parts) 222c projecting upward in the axial line X direction from the bottom surface 222b in each cutout 222. As is clear from FIGS. 1 and 2, distal ends of the engaging parts 222c of the yoke 22 are folded and bent toward the axial line X and engaged to the stepped surface 212b of the holder 21. That is, the engaging parts 222c are engaged with the holder 21 along the axial line X direction. Thus, the yoke 22 is attached to the holder 21.

As is clear from FIGS. 1 and 2, each of the cutouts 222 of the yoke 22 receives, between the two engaging parts 222c and 222c, a protruding part 212d protruding toward the outer peripheral side from the outer peripheral surface of the second annular part 212c of the outer peripheral part 212 of the holder 21 of the rotor 20. The protruding part 212d extends for a predetermined length in the circumferential direction. The outer diameter of an outer peripheral end of the protruding part 212d defined in the radial direction with respect to the axial line X may be set to be larger than the outer diameter of an outer peripheral surface of the main body 221 of the yoke 22 defined similarly. In addition, a bottom surface 212e of the protruding part 212d is in contact with and is received by the bottom surface 222b of the cutout 222 of the yoke 22.

The magnet 23 is, for example, a permanent magnet integrally formed of a magnetic material. As illustrated in FIG. 3, the magnet 23 includes S-pole regions 23a magnetized to the S-pole and N-pole regions 23b magnetized to the N-pole. The S-pole regions 23a and the N-pole regions 23b are alternately aligned in the circumferential direction. That is, change regions 23c are defined between the S-pole regions 23a and the N-pole regions 23b. In the change regions 23c, the magnetic pole changes. As described above, since the upper surface of the magnet 23 extends along substantially the same plane as the bottom surfaces 222b of the cutouts 222 of the yoke 22, the upper surface of the magnet 23 is defined to be lower than an upper surface of the main body 221 of the yoke 22 in the axial line X direction.

As is clear from FIGS. 1 and 4, the main body 221 of the yoke 22 includes a first end part 221a defined at one end in the circumferential direction and a second end part 221b defined at another end in the circumferential direction. In the present embodiment, the first end part 221a and the second end part 221b are defined along the axial line X direction. A gap (second gap) 223 is defined between the first end part 221a and the second end part 221b. That is, the peripheral length defined by an inner peripheral surface of the main body 221 of the yoke 22 is set to be smaller than the peripheral length defined by an outer peripheral surface of the magnet 23. Note that the gap 223 of the yoke 22 is preferably formed as small as possible.

Moreover, as is clear from FIG. 3, the gap 223 preferably opposes one of the change regions 23c of the magnet 23 in the radial direction. That is, the angular position of the one change region 23c around the axial line X preferably matches the angular position of the gap 223 around the axial line X as well. According to this configuration, it is possible to prevent a magnetic field from leaking from the yoke 22.

As illustrated in FIG. 4, in the present embodiment, the yoke 22 includes a cutout part 224 obtained by cutting the main body 221 of the yoke 22 at an angular position corresponding to the angular position of the gap 223 around the axial line X. In the present embodiment, the cutout part 224 is defined, for example, at the upper end of the main body 221. The angular position corresponding to the angular position of the gap 223 is 180 degrees in the present embodiment. The volume cut out by the cutout part 224 preferably coincides with the volume of the gap 223 defined between the first end part 221a and the second end part 221b.

By forming such a cutout part 224 in the main body 221, the weight balance of the yoke 22 around the axial line X is set to be kept. As a result, the rotational balance of the motor 1 is made uniform. Note that the angular position corresponding to the angular position of the gap 223 may be, for example, 120 degrees. In this case, the cutout parts 224 are formed at respective angular positions of 120 degrees from the gap 223 around the axial line X. Note that when the plurality of cutout parts 224 are provided, the sum of the volumes of the plurality of cutout parts 224 preferably coincides with the volume of the gap 223.

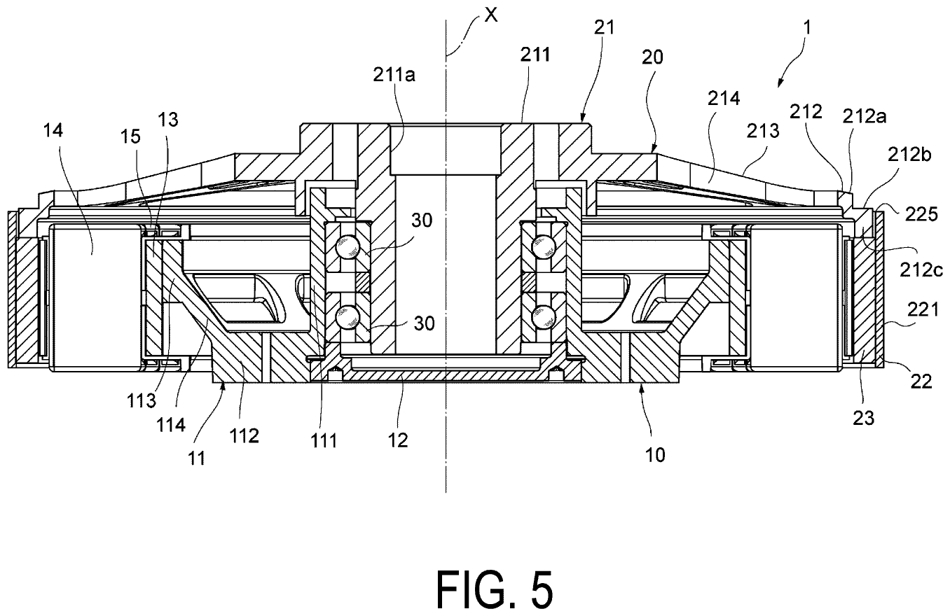

FIG. 5 is a cross-sectional view taken along line 5-5 in FIG. 1. Referring also to FIG. 5, the inner peripheral surface of the main body 221 of the yoke 22 opposes the outer peripheral surface of the outer peripheral part 212 of the holder 21 via a gap (first gap) 225. Specifically, in the present embodiment, the inner peripheral surface of the yoke 22 opposes the outer peripheral surface of the second annular part 212c of the outer peripheral part 212 of the holder 21 via the gap 225 in the radial direction. In other words, the inner peripheral surface of the yoke 22 opposes, between the cutouts 222 and 222 adjacent to each other, the outer peripheral surface of the holder 21 via the gap 225.

Note that since the lower end of the second annular part 212c is in contact with and is received by the upper end of the magnet 23, the inner peripheral surface of the yoke 22 fixed with the magnet 23 cannot oppose the outer peripheral part 212 of the holder 21. That is, as is clear from FIG. 5, the outer diameter of the outer peripheral surface of the magnet 23 defined in the radial direction is set to be larger than the outer diameter of the outer peripheral surface of the second annular part 212c of the holder 21. In the present embodiment, the difference between the outer diameters (radii) is equal to the size of the gap 225 in the radial direction.

In addition, in the cutouts 222, the inner peripheral surfaces of the two engaging parts 222c (excluding the distal ends) projecting in the axial line X direction oppose the outer peripheral surface of the holder 21 via the gap 225. On the other hand, the distal ends of the engaging parts 222c are engaged to the stepped surface 212b of the outer peripheral part 212 of the holder 21 in the axial line X direction.

In the motor 1 described above, when a current flows through the coils 14 of the stator 10, the rotor 20 rotates around the axial line X with respect to the stator 10 due to interaction with a magnetic field generated by the magnet 23. Thus, a rotating member (not illustrated) attached to the rotor 20 can rotate relative to an external device (not illustrated) attached to the stator 10.

Next, manufacture of the rotor 20 of the motor 1 will be described. In particular, attachment of the yoke 22 to the magnet 23 and attachment of the yoke 22 to the holder 21 will be described. First, an elongated plate piece for forming the yoke 22 is formed. The plate piece includes the first end part 221a and the second end part 221b at both ends in the long direction. The length of the plate piece in the long direction (from the first end part 221a to the second end part 221b) is set to be slightly shorter than the peripheral length of the outer peripheral surface of the magnet 23 formed in a cylindrical shape. The length of the plate piece in the short direction is set to be equal to the length of the yoke 22 in the axial line X direction of the motor 1. In addition, the cutouts 222, the engaging parts 222c, and the cutout part 224 are already formed in the plate piece. However, the distal ends of the engaging parts 222c may be folded and bent or may not be folded and bent.

The plate piece is rolled along the outer peripheral surface of the magnet 23. As described above, since the length of the plate piece in the long direction is slightly shorter than the peripheral length of the magnet 23, the gap 223 is formed between the first end part 221a and the second end part 221b opposing each other. That is, the difference between the length of the plate piece in the long direction and the peripheral length of the magnet 23 coincides with the size of the gap 223 in the circumferential direction. The rolled plate piece is maintained in the shape of the yoke 22 due to plastic deformation. The yoke 22 in this state is attached to the outer peripheral surface of the magnet 23 with, for example, an adhesive. Thus, an assembly of the yoke 22 and the magnet 23 is formed.

Subsequently, the assembly of the yoke 22 and the magnet 23 is attached to the holder 21. First, the engaging parts 222c of the yoke 22 and the stepped surface 212b of the holder 21 are aligned with each other. When the distal ends of the engaging parts 222c are not folded and bent, the distal end of each engaging part 222c in this state is folded and bent toward the stepped surface 212b. Thus, the engaging parts 222c are engaged to the stepped surface 212b by caulking. All the engaging parts 222c are engaged to the stepped surface 212b and thus the assembly of the yoke 22 and the magnet 23 is attached to the holder 21. When the distal ends of the engaging parts 222c are folded and bent, the holder 21 is fitted at a predetermined position with the engaging parts 222c expanded, and thus the engaging parts 222c are engaged to the stepped surface 212b. Thus, the rotor 20 is produced.

In the motor 1 described above, since the yoke 22 includes the first end part 221a and the second end part 221b, the yoke 22 is attached to the magnet 23 by being wound along the outer peripheral surface of the magnet 23. Thus, the inner peripheral surface of the yoke 22 can be in close contact with the outer peripheral surface of the magnet 23. In the present embodiment, since the gap 223 is formed between the first end part 221a and the second end part 221b, that is, since the peripheral length of the yoke 22 is shorter than the peripheral length of the magnet 23, the entire inner peripheral surface of the main body 221 of the yoke 22 can be reliably in close contact with the outer peripheral surface of the magnet 23. As a result, it is possible to suppress formation of a gap causing magnetic resistance between the inner peripheral surface of the yoke 22 and the outer peripheral surface of the magnet 23, and thus improve motor performance.

Moreover, in the motor 1, the inner peripheral surface of the yoke 22 opposes the outer peripheral surface of the second annular part 212c of the holder 21 via the gap 225. The outer peripheral surface of the second annular part 212c of the holder 21 does not interfere with the inner peripheral surface of the yoke 22 in the radial direction. Thus, the presence of the second annular part 212c of the holder 21 does not prevent the inner peripheral surface of the yoke 22 from being in close contact with the outer peripheral surface of the magnet 23. As a result, magnetic resistance generated between the yoke 22 and the magnet 23 can be made as small as possible.

Furthermore, since a yoke having a cylindrical shape continuous in the circumferential direction is conventionally produced in a pressing process and a drawing process, a material of a part other than the cylindrical shape forming the yoke is discarded. Further, in the pressing process and the drawing process, it is difficult to perform fine dimensional adjustment of the plate thickness of the yoke. On the other hand, according to the motor 1 of the present embodiment, it is only required to roll the elongated plate piece including the first end part 221a and the second end part 221b into the shape of the yoke 22 in producing the yoke 22. Thus, it is possible to reduce a material to be discarded in forming the yoke 22. Further, since the plate thickness of the plate piece coincides with the plate thickness of the yoke 22, it is extremely easy to adjust the plate thickness.

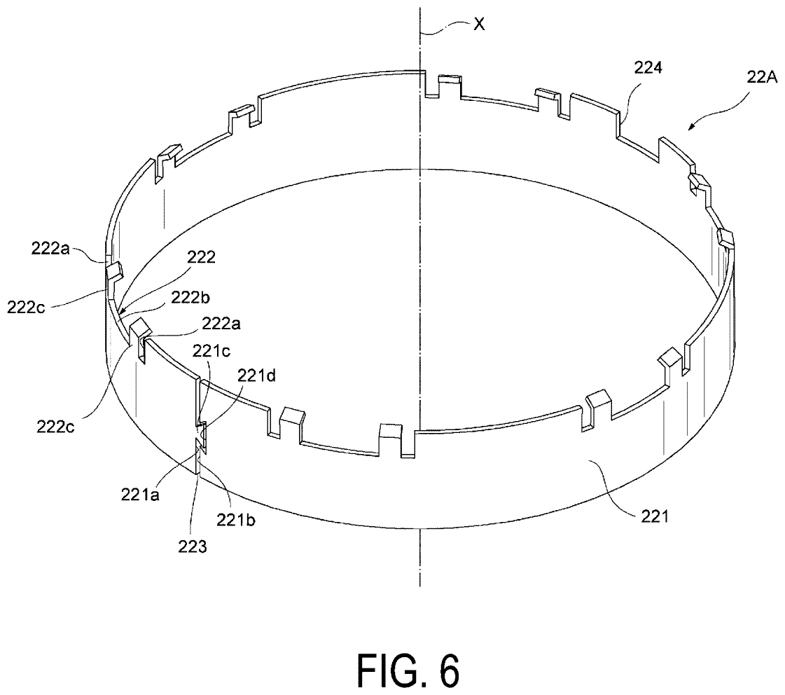

FIG. 6 is a perspective view of a yoke 22A alone according to a modification example, the perspective view schematically illustrating a structure of the yoke 22A. Note that configurations similar to the configurations of the above-described yoke 22 are denoted by the same reference numerals. As illustrated in FIG. 6, a first end part 221a of the yoke 22A includes a projecting part (second projecting part) 221c projecting in the circumferential direction, while a second end part 221b of the yoke 22A includes a recessed part 221d recessed in the circumferential direction and engaged with the projecting part 221c. In the present embodiment, the shape of the projecting part 221c is defined as such a shape that the size of the projecting part 221c in the axial line X direction increases as the projecting part 221c projects further in the circumferential direction from the first end part 221a. The shape of the recessed part 221d is defined as such a shape that the size of the recessed part 221d in the axial line X direction increases as the recessed part 221d is recessed further in the circumferential direction from the second end part 221b.

As is clear from FIG. 6, in the present embodiment, the projecting part 221c and the recessed part 221d are formed in, for example, a trapezoidal shape in a side view of the yoke 22. The projecting part 221c is defined to have a trapezoidal shape including an upper base defined along the first end part 221a and a lower base defined parallel to the upper base. Similarly, the recessed part 221d is defined to have a trapezoidal shape including an upper base defined along the second end part 221b and a lower base defined parallel to the upper base. The maximum size of the projecting part 221c defined in the axial line X direction is set to be larger than the minimum size of the recessed part 221d similarly defined in the axial line X direction. In the example of FIG. 6, a gap 223 is also formed between the projecting part 221c and the recessed part 221d.

With such a structure of the yoke 22A, it is possible to exert a similar working effect as the effect of the above-described embodiment. Further, the projecting part 221c can be engaged with the recessed part 221d. Specifically, the maximum size of the projecting part 221c defined in the axial line X direction is set to be larger than the minimum size of the recessed part 221d similarly defined in the axial line X direction. Thus, for example, even if a centrifugal force acts on the yoke 22A due to rotation of the rotor 20 and thus the diameter of the yoke 22A is increased, or even if the gap 223 is increased due to thermal expansion of the magnet 23 and the yoke 22A, the first end part 211a can be reliably engaged with the recessed part 221d, so that the close contact between the yoke 22A and the magnet 23 is reliably maintained.

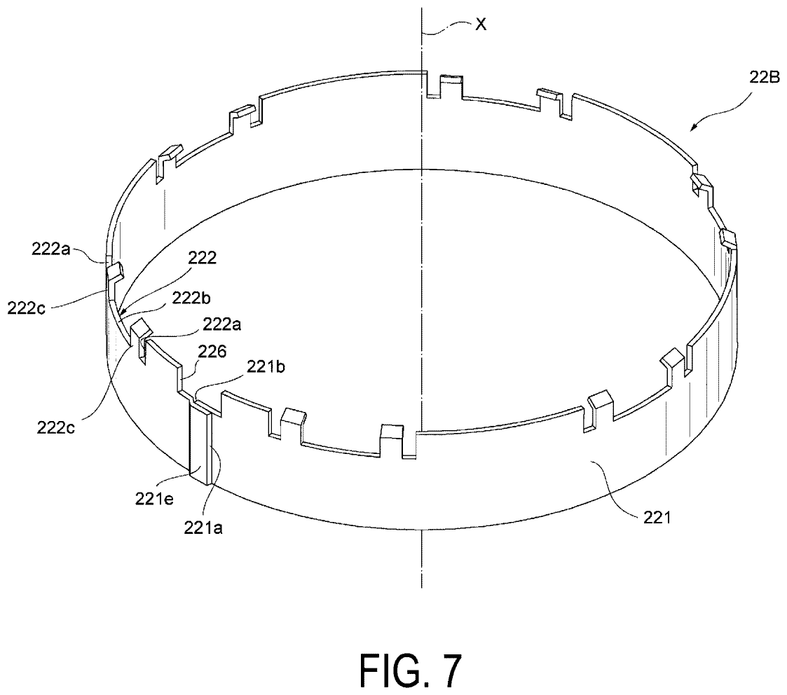

FIG. 7 is a perspective view of a yoke 22B alone according to another modification example, the perspective view schematically illustrating a structure of the yoke 22B. Note that configurations similar to the configurations of the above-described yoke 22 are denoted by the same reference numerals. As illustrated in FIG. 7, a first end part 221a of the yoke 22B may be disposed at an outer peripheral surface of a main body 221 beyond a second end part 221b in the circumferential direction. Thus, the main body 221 of the yoke 22B may include an overlapping part 221e. In other words, the peripheral length defined by an inner peripheral surface of the main body 221 of the yoke 22B is set to be larger than the peripheral length defined by an outer peripheral surface of a magnet 23. The peripheral length of the overlapping part 221e is set to be an angular range of, for example, about 5 degrees around the axial line X.

In the yoke 22B, instead of the above-described cutout part 224, a cutout part 226 is disposed at the same angular position as the overlapping part 221e. The volume cut out by the cutout part 226 preferably coincides with the volume of the overlapping part 221e. By forming such a cutout part 226, the weight balance of the yoke 22 around the axial line X is set to be kept. As a result, the rotational balance of the motor 1 is made uniform.

Note that, instead of this cutout part 226, for example, a balance part (not illustrated) having the same volume as the volume of the overlapping part 221e may be provided at an angular position of 180° from the overlapping part 221e around the axial line X. The balance part is provided at the outer peripheral surface of the main body 221, for example. The weight balance of the yoke 22 may be kept by this balance part. With such a structure of the yoke 22B, it is possible to exert a similar working effect as the effect of the above-described embodiment.

As described above, the motor 1 has been described with reference to the preferred embodiment, but the motor 1 is not limited to the above-described embodiment. For example, the present invention can also be applied to a motor other than a brushless motor, and a motor of an inner-rotor type. Further, for example, the stepped surface 212b may be a recessed part formed for each engaging part 222c. In addition, although the outer peripheral part 212 of the holder 21 is formed with an annular part continuous in the circumferential direction, the outer peripheral part 212 may be formed with, for example, a plurality of pieces aligned in the circumferential direction, the respective pieces being continuous with the outer peripheral ends of the spokes 213.

Moreover, the present invention is not limited to the motor 1 according to the embodiment described above, and includes various aspects included in concepts and claims of the present invention. Further, the configurations may be selectively combined as appropriate so as to achieve at least part of the objects and the effects described above. For example, each of the configurations in the embodiment described above may be changed as appropriate according to a specific usage aspect of the present invention.

### REFERENCE SIGNS LIST

1 Motor, 10 Stator, 11 Housing, 12 Pusher, 12a Male screw, 13 Stator core, 14 Coil, 15 Insulator, 20 Rotor, 21 Holder, 22, 22A, 22B Yoke, 23 Magnet, 23a S-pole region, 23b N-pole region, 23c Change region, 30 Bearing, 111 Inner wall part, 111a Female screw, 112 Attachment part, 112a First opening part, 112b Screw hole, 113 Outer wall part, 114 Connection part, 114a Second opening part, 115 Annular part, 131 Base end part, 132 Teeth, 133 Distal end part, 211 Inner peripheral part, 211a Through hole, 212 Outer peripheral part, 212a First annular part, 212b Stepped surface, 212c Second annular part, 212d Protruding part, 212e Bottom surface, 213 Spoke, 214 Opening part, 221 Main body, 221a First end part, 221b Second end part, 221c Projecting part (second projecting part), 221d Recessed part, 221e Overlapping part, 222 Cutout, 222a Side surface, 222b Bottom surface, 222c Engaging part (first projecting part), 223 Gap (second gap), 224 Cutout part, 225 Gap (first gap), 226 Cutout part, X axial line

1. A motor comprising:
a rotor;
a stator opposing the rotor, wherein
the rotor includes a magnet, a yoke in contact with the magnet, and a holder holding the magnet and the yoke,
the yoke includes a first end part defined at one end in a circumferential direction and a second end part defined at another end in the circumferential direction, and
an inner peripheral surface of the yoke opposes an outer peripheral surface of the holder via a first gap in a radial direction.

2. The motor according to claim 1, wherein
a second gap is defined between the first end part and the second end part.

3. The motor according to claim 2, wherein
the yoke includes a cutout part obtained by cutting the yoke at an angular position corresponding to an angular position of the second gap around an axial line of the rotor.

4. The motor according to claim 2, wherein
the magnet includes a plurality of magnetic poles and a change region,
in the change region, one magnetic pole of the plurality of magnetic poles changes to another magnetic pole of the plurality of magnetic poles, and
the second gap opposes the change region in the radial direction.

5. The motor according to claims 1, wherein
the yoke includes a first projecting part projecting in an axial direction of the rotor, and the first projecting part is engaged with the holder along the axial direction.

6. The motor according to claims 1, wherein
the first end part includes a second projecting part projecting in the circumferential direction, and
the second end part includes a recessed part engaged with the second projecting part.
